(19) United States
(12) Patent Application Publication
(10) Pub. No.: US 2005/0252706 A1
(43) Pub. Date: Nov. 17, 2005

(54) An All-Terrain Electronically Powered Vehicle And Temperature Sensing Motor Controller For Use Therein

(76) Inventor: Ralph M. Thomas, Ellijay, GA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(21) Appl. No.: 10/905,620

(22) Filed: Jan. 13, 2005

Related U.S. Application Data
(63) Continuation-in-part of application No. 10/633,837, filed on Aug. 4, 2003, now abandoned.

(51) Int. Cl. B62M 23/02

(52) U.S. Cl. 180/205; 180/65.1

(57) ABSTRACT

The present invention relates to an electrically powered all-terrain vehicle, wherein the vehicle comprises at least two hub motors 3, 6. The hub motors 3, 6 each comprise a temperature sensor for measuring the operating temperature of the hub motor 3, 6 and further, each hub motor 3, 6 has the capability to operate in a generator mode in order to generate an output current. Each hub motor 3, 6 is mechanically associated with a wheel assembly, a power supply 1 and at least one motor controller 2 that is in electrical communication with each hub motor 3, 6 and the power supply 1, wherein the motor controller 2 continuously monitors the operating temperature of each hub motor 3, 6.

This application is a continuation-in-part of U.S. application Ser. No. 10/633,837, filed Aug. 4, 2003, the entirety of which is incorporated herein.

### FIELD OF INVENTION

The present invention generally relates to electrically powered vehicles, more particularly to electrically powered vehicles wherein the motor temperatures of the vehicles are constantly monitored and the acquired temperature data is used to optimize the performance of the vehicle.

### BACKGROUND

Presently the use of all-terrain electrically powered driving vehicles is increasing in popularity. As a result of this increased usage, vehicle operators consistently require higher demands of the performance of their vehicles. The traversal of difficult terrains demands the increased mobility and traction operations of a vehicle in order to insure the safety of the vehicle operator and the optimization of the vehicle's performance. An additional potential negative factor that can compromise a vehicle's performance is that presently utilized electrically powered all-terrain vehicle motors are either to heavy or to light to be efficient during high power demand. Further, in the event that a motor begins to overheat currently utilized motor protective electronic circuitry completely shuts the motor system down for a few minutes until the motor cools down, thus severing as a potential vehicle-maneuvering hazard to an operator difficult or dangerous riding conditions.

Therefore, there exists a need for an electrically powered all-terrain vehicle that is equipped with increased vehicle mobility and tractions operations. Further, there is a need for an electrically powered all-terrain vehicle wherein the vehicle's motor temperature is continuously monitored in order to ensure the optimal usage of the motor and to prevent damage to the motor due to excessive operating temperatures without resorting to the vehicle's cutting off the motor in order to obtain such goals.

### SUMMARY

The present invention relates to an electrically powered all-terrain vehicle. The vehicle is enabled with anti-lock electric braking functionality, traction control functionality, pedelec functionality and vehicle motor temperature monitoring functionality.

An aspect of the present invention comprises an electrically powered all-terrain vehicle. The electrically powered all-terrain vehicle comprises at least two hub motors, wherein each hub motor comprises a temperature sensor for measuring the operating temperature of the hub motor. Each hub motor has the capability to operate in a generator mode in order to generate an output current and further, each hub motor is mechanically associated with a wheel assembly. The vehicle also comprises a power supply and at least one motor controller in electrical communication with each hub motor and the power supply, wherein the motor controller continuously monitors the operating temperature of each hub motor.

A feature of the electrically powered all-terrain vehicle is that the motor controller monitors the rpm, input current to the hub motors and generated output current of each hub motor. In the event that the motor controller determines that a hub motor's temperature is within a predetermined temperature range then the motor controller will decrease the current to the hub motor.

Another feature is the motor controller's capability to determine the amount of current required by each hub motor based upon input from a vehicle user interface. Additionally, the power supply of the vehicle comprises recharging circuitry. And yet further, a braking function of the wheel assembly initiates the generator mode within the motor hub.

Additional features of the electrically powered all-terrain vehicle provide that in the event that the rpm and output current of a hub motor is lower than the rpm and output current of the other hub motor, the motor controller will transmit a command to the slower hub motor to reduce the braking power on the slower hub motor until the monitored rpm of the hub motors are equal.

Also, in the event that the rpm of a hub motor is increasing while the input current of the hub motor is decreasing, the motor controller will transmit a command to the accelerating motor hub to switch to generator mode until the monitored rpm's of the hub motors are equal.

A yet further feature allows for the employment of a pedal assembly, wherein the pedal assembly activates the hub motors of the electrically powered all-terrain vehicle upon use. Also, the vehicle human interface of the electrically powered all-terrain vehicle can comprises a throttle.

Another aspect of the present invention comprises an electrically powered all-terrain vehicle that comprises at least two hub motors that are mechanically associated with a wheel assembly. Each hub motor comprises a temperature sensor for measuring the operating temperature of the hub motor. Each hub motor has the capability to operate in a generator mode in order to generate an output current. Additionally, the electrically powered all-terrain vehicle comprises a power supply and at least one motor controller that is in electrical communication with each hub motor and the power supply. The motor controller continuously monitors the operating temperature, rpm and generated output current of each hub motor. In the event that the rpm and output current of a hub motor is lower than the rpm and output current of the other hub motor, the motor controller will transmit a command to the slower hub motor to reduce the braking power on the slower hub motor until the monitored rpm's of the hub motors are equal.

A yet further aspect of the present invention comprises an electrically powered all-terrain vehicle comprising at least two hub motors, wherein each hub motor comprises a temperature sensor for measuring the operating temperature of the hub motor. Further, each hub motor has the capability to operate in a generator mode in order to generate an output current, also, each hub motor is mechanically associated with a wheel assembly. The vehicle also comprises a power supply and at least one motor controller in electrical communication with each hub motor and the power supply. The motor controller continuously monitors the operating temperature of each hub motor. In the event that the rpm of a hub motor is increasing while the input current of the hub motor is decreasing the motor controller will transmit a command to hub motor to switch to generator mode until the monitored rpm's of the hub motors are equal.

A yet another aspect of the present invention comprises an electrically powered all-terrain vehicle that comprises a pedal assembly, wherein the pedal assembly is capable of propelling the all-terrain vehicle. The vehicle also comprises at least two hub motors, wherein the employment of the pedal assembly activates the hub motor. Each hub motor comprises a temperature sensor for measuring the operating temperature of the hub motors. Further, each hub motor has the capability to generate an output current and further, each hub motor is mechanically associated with a wheel assembly. The vehicle also comprises a power supply and at least one motor controller that are in electrical communication with each hub motor and the power supply, wherein the motor controller continuously monitors the operating temperature of each hub motor.

### DETAILED DESCRIPTION OF THE DRAWINGS

The accompanying drawings illustrate one or more embodiments of the invention and, together with the written description, serve to explain the principles of the invention. Wherever possible, the same reference numbers are used throughout the drawings to refer to the same or like elements of an embodiment, and wherein:

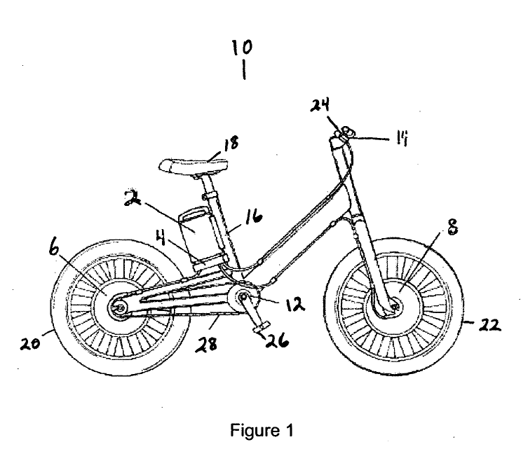

FIG. 1 illustrates an aspect of an all-terrain vehicle of the present invention.

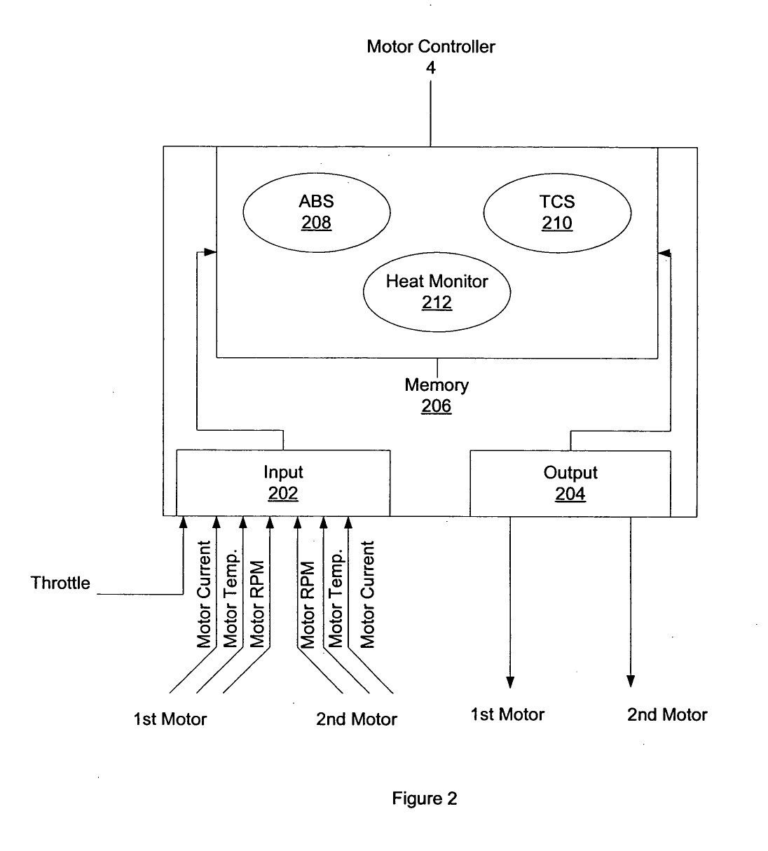

FIG. 2 is a diagram showing a motor controller that can be used within aspects of the present invention.

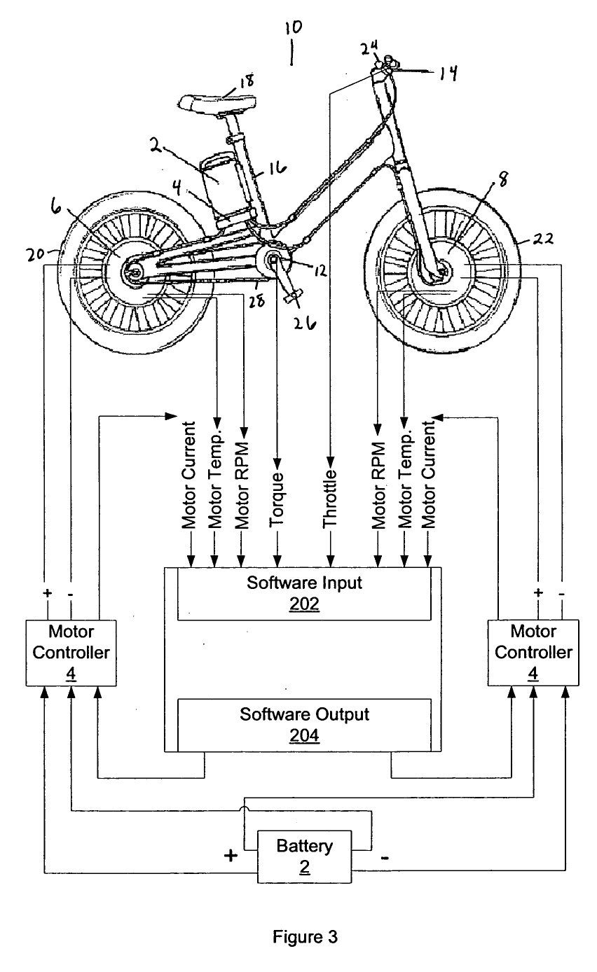

FIG. 3 is a diagram showing the interaction between an all-terrain vehicle and a motor controller that can be used within aspects of the present invention.

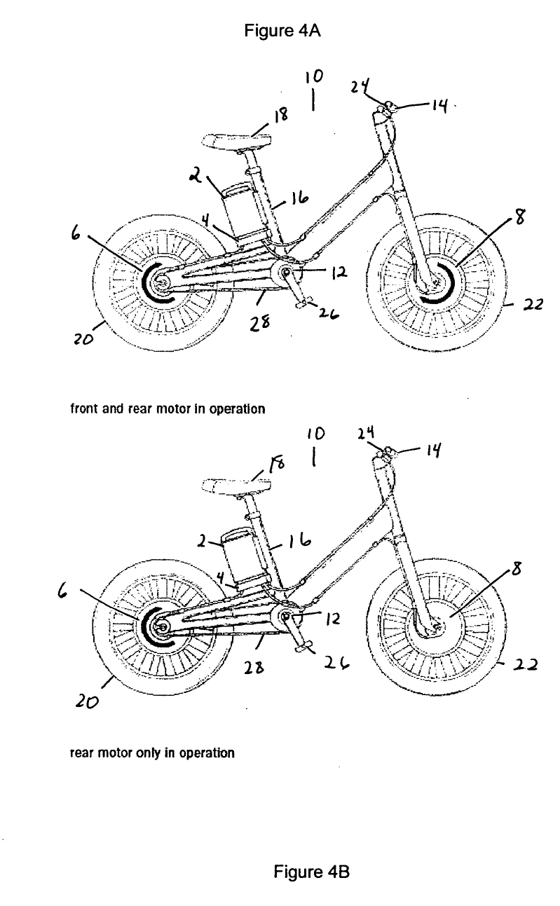

FIG. 4A illustrates an aspect of an all-terrain vehicle of the present invention wherein the front and rear hub motors are used in combination.

FIG. 4B illustrates an aspect of an all-terrain vehicle of the present invention wherein the rear hub motor is in operation.

### DETAILED DESCRIPTION

One or more exemplary embodiments of the invention are described below in detail. The disclosed embodiments are intended to be illustrative only since numerous modifications and variations therein will be apparent to those of ordinary skill in the art. In reference to the drawings, like numbers will indicate like parts continuously throughout the views.

Aspects of the present invention will initially be described in reference to FIG. 1. Figure illustrates an aspect of the vehicle of the present invention in a bicycle embodiment. The vehicle 10 features a frame 16, handlebars 24, a throttle 14 mounted upon the handlebars 24 and a seat 18. Additionally, the vehicle 10 comprises a rear wheel assembly 20 and a front wheel assembly 22. The front and rear wheel assemblies 20 and 22 each comprise a tire supporting rim and a tire.

Propulsion for the vehicle 10 is provide by a rear hub motor 6 and a front hub motor 8, wherein each hub motor is 6, 8 is in mechanical connection with the wheel assemblies 20 and 22, respectively. The hub motors 6, 8 can comprise conventional small, compact hub motors that are known in the art. The hub motors 6, 8 can embody suitable conventional motors as long as the hub motor 6, 8 functions are capable of providing a sufficient torque force to rotationally drive the supporting rims of the front and rear wheel assemblies 20 and 22. The hub motors 6, 8 are typically mounted inside the tire supporting rims of the front and rear wheel assemblies 20 and 22.

The operational temperatures of the hub motors 6, 8 are continuously monitored by heat sensors (not shown) that are incorporated into the hub motor 6, 8 structures. Power for the hub motors 6, 8 is provided by a power supply 2, the power supply 2 being mounted to the vehicle's 10 frame 16. The power supply 2 may comprise any conventional transportable power source, for purposes of description of the present invention a conventional battery system is utilized as a power supply system 2. The battery of the power system 2 is also provided with conventional battery recharging circuitry in order to provide for the recharging of the battery. The power provided by the power supply is regulated and transmitted to the hub motors 6, 8 via a motor controller 4. As illustrated in FIG. 1, one motor controller is used to control two hub motors 6, 8, however multiple motor controllers 4 may also be implemented (one motor controller 4 for each hub motor 6, 8, See FIG. 3).

As illustrated in FIG. 2, the motor controller 4 comprises a processor (not shown) and main memory 206 in addition to an input interface 202 and an output interface 204. The motor controller 4 also comprises software programs, wherein the programs are executed independently and have the capability to communicate with each other if the need arises. The programs include an anti-lock electrical braking program 208, a traction control program 210, a motor controller program (not shown) and a motor temperature monitoring program 212. The motor controller's 2 programs are illustrated for purposes of clarity as being executable in a main memory 206, but as persons skilled in the art will understand they may not in actuality reside simultaneously or in their entireties in the memory 206. FIG. 3 illustrates the relationship of the software programs of the motor controller 2 and the respective input and outputs that are acquired and evaluated using the software programs 208, 210 and 212 within an embodiment of the present invention that comprises two motor controllers 4, one motor controller 4 per each hub motor 6, 8.

The present invention also provides for the electrical braking of the vehicle's 10 hub motors 6, 8 in addition to a regenerative braking functionality for the hub motors 6, 8. Electrical vehicle braking is accomplished by the motor controller 4 electrically switching the hub motors 6, 8 to a generator mode, wherein the hub motor is effectively powered down and thereafter the hub motors 6, 8 being in generator mode convert the vehicle's 10 motion into electricity instead of using electricity from the power supply 2 to propel the vehicle 10. Regenerative braking allows for a vehicle 10 to recapture and store part of the kinetic energy that the vehicle 10 loses when braking. Conventional friction-based brakes are provided for use when rapid or powerful braking is required (not shown).

An additional source of propulsion for the vehicle 10 is provided by human muscle power exerted on the pair of pedals 26 (one shown) via a power drive train 28 that is in mechanical connection with the rear wheel assembly 20. Aspects of the present invention allow for the vehicle 10 to be independently propelled stricly using electric power or propelled under human power. Further aspects allow for the the two modes to be utilized in conjunction, for this aspect a torque sensor 12 is provided in the power drive train to monitor the torque generated by a vehicle 10 operator. The generated torque force is used as an input factor by the motor controller 4 to assist in the motor control operations of the motor controller 4. A human interface or throttle is used to regulate the power to the hub motors 6, 8. The hub motors 6, 8 powers are regulated by a vehicle 10 user's use of a twist-grip or knob.

As illustrated in FIGS. 2 and 3, the motor controller 4 of the present invention also performs the function of monitoring the temperatures of the hub motors 6, 8. This anti-overheating function is critical for a lightweight off-road capable electric vehicle 10 since the vehicle's 10 motors have to be lightweight and powerful at the same time. Presently, motors are either to heavy or light to be efficient, or if the motors begin to overheat their protective electronic circuitry completely shuts the motor system down for a few minutes until the motor cools down. The anti-heating function of the present invention allows for the motor controller 4 to provide that the motors 6, 8 cool down without shutting down the motors 6, 8. This particular anti-overheating functionality is very critical in the design and implementation of a vehicle 10 that is lightweight and reliable and never shuts down due to overheating-even in situations wherein the drive system is being driven at the edge of its performance capabilities.

The temperature of each hub motor 6, 8 is monitored continuously by the hub motors' 6, 8 heat sensors. The motor controller's 4 processor executes the temperature monitoring software program 212 that monitors the temperature of the respective hub motors 6, 8 and determines if the respective temperatures of the hub motors 6, 8 are approaching a critical heat range. Data relating to the current temperature of the hub motors 6, 8, the current being transmitted to the hub motors 6, 8, the rpm of the hub motors 6, 8 and the current generated by the hub motors 6, 8 is input to the motor controller 4 and evealuated by the program 212.

In the event that the motor controller 4 determines that there is an impending possibility that a hub motor 6, 8 will reach the critical temperature range level, in order to avoid damage to the motor 6, 8, the motor controller 4 will reduce the current flow to the hub motor 6, 8 until it determines that the hub motor 6, 8 will not reach the critical temperature. This monitoring function is continuously performed on each hub motor 6, 8 and a result of the function is that there may be a shift of torque from one motor to the other.

The present inventive vehicle 10 has two operational modes: a manual mode and an automatic mode. A selector switch (not shown) is provided in order to allow a vehicle 10 operator to switch between the vehicle's 10 operational modes. The selector switch can be situated upon the handlebars 24 of the vehicle 10. The motor control 4 is equipped to accept operational mode input information from the selector switch. When the vehicle 10 is operated in the manual mode the vehicle 10 user can decide whether to operate the vehicle 10 using the rear hub motor 6 or the front hub motor 8 or using the hub motors 6, 8 in conjunction with each other (as illustrated in FIGS. 4A and 4B). In contrast, when operating in the automatic mode, the motor controller 4 regulates the control of both hub motors 6, 8 in order to optimize the efficient and safe usage of both hub motors 6, 8.

This motor regulation optimization function is accomplished by determinations made by the motor controller 4 based upon input from the hub motors 6, 8 in regard to the rpm, current input and generated output current of each respective hub motor 6, 8. Further, in the manual and automatic modes, the human interface or throttle 14 generates a signal to smoothly control the hub motors 6, 8, the signal being proportional to the desired amount of power the vehicle 10 user desires in order to propel the vehicle 10.

The throttle 14 permits the vehicle 10 operator to control the speed of the vehicle 10. The throttle 14 transmits a signal to the motor controller 4; the motor controller 4 controls the voltage and current available to the hub motors 6, 8. The throttle 14 can comprise a cable-pull system, potentiometers, hall-effect sensors or any other conventional throttle system that can jointly control the hub motors 6, 8. A twist-grip throttle control, lever throttle control throttle or any conventional throttle control assembly can provide the control of the throttle 14.

Aspects of the present invention provide the motor controller 4 of the vehicle 10 with the capability to perform anti-lock electrical braking functions. The motor controller 4 executes a software program 208, wherein the electrical braking functions of the vehicle 10 are monitored and controlled. For example, in the instance that a wheel of the vehicle 10 is slipping, the wheel will have a reduced rpm rate. As a result of evaluating the rpm and current data, the motor controller 4 will transmit a lower braking current to the wheel and concurrently transmit a higher braking current to the non-slipping wheel. The result of reducing the braking effect on the wheel and raising it on the other wheel the vehicle 10 is that the vehicle 10 stabilizes more efficiently, especially when traversing difficult terrain such as steep downhill slopes or uneven surfaces.

Further, while receiving a braking current, both motors will also be in current generation mode. While braking, the motor controller 4 continuously compares the rpm and generated current of the hub motors 6, 8. In the instance that the rpm and generated current output of one hub motor 6, 8 is lower than the other hub motor 6, 8, the motor controller 4 will reduce the braking current to the slower hub motor 6, 8. If a further stabilization need exists, the motor controller may even briefly switch the slower hub motor 6, 8 back into acceleration mode for a time until both hub motors 6, 8 are operating at the same rpm and generating comparable output currents.

Further aspects of the present invention provide the motor controller 4 with an executable software program 210 that has the capability to perform vehicle traction control functions in order to improve a vehicle 10 user's driving handling when operating the vehicle 10. When implementing the traction control function the motor controller 4 constantly compares the rpm and the input current into the hub motors 6, 8. In the instance that the rpm of one hub motor 6, 8 is accelerating while the input current is being reduced then the accelerating hub motor 6, 8, will be switched into generator mode (or braking mode) until both hub motors resume the same rpm level. This function makes it possible to drive a vehicle 10 uphill with the maximum possible current without loosing control of the vehicle 10 in the instance that the surface under one wheel is slippery.

Another aspect of the present inventive vehicle 10 provides a vehicle 10 user with a pedelec motor-assist function upon when desired. In the pedelec motor-assist mode, the hub motors 6, 8 are only activated when the user pedals the vehicle 10 in the manual mode. When the user starts to pedal then both hub motors 6, 8 are simultaneously activated. The power of the hub motors 6, 8 motors assistance is calculated and coupled to the effort of the user by way of data provided by the torque sensor 12 to the motor controller 4.

An aspect of the present invention comprises an electrically powered all-terrain vehicle 10 that comprises at least two hub motors 6, 8, wherein each hub motor 6, 8 comprises a temperature sensor for measuring the operating temperature of the hub motor 6, 8. Each hub motor 6, 8 has the capability to operate in a generator mode in order to generate an output current and further, each hub motor 6, 8 is mechanically associated with a wheel assembly 20, 22. The vehicle 10 also comprises a power supply 2 and at least one motor controller 4 that is in electrical communication with each hub motor 6, 8 and the power supply 2, wherein the motor controller 4 continuously monitors the operating temperature of each hub motor 6, 8.

A feature of the electrically powered all-terrain vehicle 10 is that the motor controller 4 monitors the rpm, input current to the hub motors 6, 8 and generated output current of each hub motor 6, 8. In the event that the motor controller 4 determines that a hub motor's 6, 8 temperature is within a predetermined temperature range then the motor controller 4 will decrease the current to the hub motor 6, 8.

Another feature is the motor controller's 4 capability to determine the amount of current required by each hub motor 6, 8 based upon input from a vehicle 10 user interface. Additionally, the power supply of the vehicle 10 comprises recharging circuitry. And yet further an electrical braking function of the wheel assembly initiates the generator mode within the motor hub 6, 8.

Additional features of the electrically powered all-terrain vehicle 10 provide that in the event that the rpm and output current of a hub motor 6, 8 is lower than the rpm and output current of the other hub motor 6, 8, the motor controller 4 will transmit a command to the slower hub motor 6, 8 to reduce the braking power on the slower hub motor 6, 8 until the monitored rpm of the hub motors 6, 8 are equal.

Also, in the event that the rpm of a hub motor 6, 8 is increasing while the input current of the hub motor 6, 8 is decreasing, the motor controller 4 will transmit a command to the accelerating motor hub 6, 8 to switch to generator mode until the monitored rpm's of the hub motors 6, 8 are equal.

A yet further feature allows for the employment of a pedal assembly 26, wherein the pedal assembly 26 activates the hub motors 6, 8 of the electrically powered all-terrain vehicle 10 upon use. Also, the vehicle 10 human interface of the electrically powered all-terrain vehicle 10 can comprises a throttle 14.

Another aspect of the present invention comprises an electrically powered all-terrain vehicle 10 that comprises at least two hub motors 6, 8 that are mechanically associated with a wheel assembly 20, 22. Each hub motor 6, 8 comprises a temperature sensor for measuring the operating temperature of the hub motor 6, 8. Each hub motor 6, 8 has the capability to operate in a generator mode in order to generate an output current. Additionally, the electrically powered all-terrain vehicle 10 that comprises a power supply 2 and at least one motor controller 4 that is in electrical communication with each hub motor 6, 8 and the power supply 2. The motor controller 4 continuously monitors the operating temperature, rpm and generated output current of each hub motor 6, 8. In the event that the rpm and output current of a hub motor 6, 8 is lower than the rpm and output current of the other hub motor 6, 8, the motor controller 4 will transmit a command to the slower hub motor 6, 8 to reduce the electronic braking power on the slower hub motor 6, 8 until the monitored rpm of the hub motors 6, 8 are equal.

A yet further aspect of the present invention comprises an electrically powered all-terrain vehicle 10 comprising at least two hub motors 6, 8, wherein each hub motor 6, 8 comprises a temperature sensor for measuring the operating temperature of the hub motor 6, 8. Further, each hub motor 6, 8 has the capability to operate in a generator mode in order to generate an output current; also, each hub motor 6, 8 is mechanically associated with a wheel assembly 20, 22. The vehicle 1 0 also comprises a power supply 2 and at least one motor controller 4 that is in electrical communication with each hub motor 6, 8 and the power supply 2. The motor controller 4 continuously monitors the operating temperature of each hub motor 6, 8. In the event that the rpm of a hub motor 6, 8 is increasing while the input current of the hub motor 6, 8 is decreasing the motor controller 4 will transmit a command to motor hub 6, 8 to switch to generator mode until the monitored rpm of the hub motors 6, 8 are equal.

A yet another aspect of the present invention comprises an electrically powered all-terrain vehicle 10 that comprises a pedal assembly 26, wherein the pedal assembly 26 is capable of propelling the all-terrain vehicle 10. The vehicle 10 also comprises at least two hub motors 6, 8, wherein the employment of the pedal assembly 26 activates the hub motor 6, 8. Each hub motor 6, 8 comprises a temperature sensor for measuring the operating temperature of the hub motors 6, 8. Further, each hub motor 6, 8 has the capability to generate an output current and further, each hub motor 6, 8 is mechanically associated with a wheel assembly 20, 22. The vehicle 10 also comprises a power supply 2 and at least one motor controller 4 that are in electrical communication with each hub motor 6, 8 and the power supply 2, wherein the motor controller 4 continuously monitors the operating temperature of each hub motor 6, 8.

Therefore, it will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. An electrically powered all-terrain vehicle, comprising:
at least two hub motors, wherein each hub motor comprises a temperature sensor for measuring the operating temperature of the hub motor and each hub motor has the capability to operate in a generator mode in order to generate an output current and further, each hub motor is mechanically associated with a wheel assembly;
a power supply; and
at least one motor controller in electrical communication with each hub motor and the power supply, wherein the motor controller continuously monitors the operating temperature of each hub motor.

2. The vehicle of claim 1, wherein the motor controller monitors the rpm, input current to the hub motors and generated output current of each hub motor.

3. The vehicle of claim 2, wherein if the motor controller determines that a hub motor's temperature is within a predetermined temperature range then the motor controller will decrease the current to the hub motor.

4. The vehicle of claim 3, wherein the motor controller determines the amount of current required by each hub motor based upon input from a vehicle user interface.

5. The vehicle of claim 4, wherein if the rpm and output current of a hub motor is lower than the rpm and output current of the other hub motor, the motor controller will transmit a command to the slower hub motor to reduce the braking power on the slower hub motor until the monitored rpm of the hub motors are equal.

6. The vehicle of claim 5, wherein if the rpm of a hub motor is increasing while the input current of the hub motor is decreasing the motor controller will transmit a command to the accelerating motor hub to switch to generator mode until the monitored rpm of the hub motors are equal.

7. The vehicle of claim 6, wherein the employment of the pedal assembly activates the hub motors.

8. The vehicle of claim 7, wherein the vehicle human interface comprises a throttle.

9. An electrically powered all-terrain vehicle, comprising:
at least two hub motors that are mechanically associated with a wheel assembly, wherein each hub motor comprises a temperature sensor for measuring the operating temperature of the hub motor and each hub motor has the capability to operate in a generator mode in order to generate an output current;
a power supply; and
at least one motor controller in electrical communication with each hub motor, the power supply, wherein the motor controller continuously monitors the operating temperature, rpm and generated output current of each hub motor, further, if the rpm and output current of a hub motor is lower than the rpm and output current of the other hub motor, the motor controller will transmit a command to the slower hub motor to reduce the braking power on the slower hub motor until the monitored rpm of the hub motors are equal.

10. The vehicle of claim 9, wherein the motor controller monitors the rpm, input current to the hub motors and generated output current of each hub motor.

11. The vehicle of claim 10, wherein if the motor controller determines that a hub motor's temperature is within a predetermined temperature range then the motor controller will decrease the current to the hub motor.

12. The vehicle of claim 11, wherein the motor controller determines the amount of current required by each hub motor based upon input from a vehicle user interface.

13. The vehicle of claim 12, wherein the power supply comprises recharging circuitry.

14. The vehicle of claim 13, wherein a wheel assembly braking function initiates the motor hub generator mode.

15. The vehicle of claim 14, wherein the vehicle human interface comprises a throttle.

16. An electrically powered all-terrain vehicle, comprising:
at least two hub motors, wherein each hub motor comprises a temperature sensor for measuring the operating temperature of the hub motor and each hub motor has the capability to operate in a generator mode in order to generate an output current and further, each hub motor is mechanically associated with a wheel assembly;
a power supply; and
at least one motor controller in electrical communication with each hub motor and the power supply, wherein the motor controller continuously monitors the operating temperature of each hub motor further, if the rpm of a hub motor is increasing while the input current of the hub motor is decreasing the motor controller will transmit a command to hub motor to switch to generator mode until the monitored rpm of the hub motors are equal.

17. The vehicle of claim 16, wherein the motor controller monitors the rpm, input current to the hub motors and generated output current of each hub motor.

18. The vehicle of claim 17, wherein if the motor controller determines that a hub motor's temperature is within a predetermined temperature range then the motor controller will decrease the current to the hub motor.

19. The vehicle of claim 18, wherein the motor controller determines the amount of current required by each hub motor based upon input from a vehicle user interface.

20. The vehicle of claim 19, wherein the power supply comprises recharging circuitry.

21. The vehicle of claim 20, wherein a wheel assembly braking function initiates the motor hub generator mode.

22. The vehicle of claim 21, wherein the vehicle human interface comprises a throttle.

23. An electrically powered all-terrain vehicle, comprising:
a pedal assembly, wherein the pedal assembly is capable of propelling the all-terrain vehicle;
at least two hub motors, wherein the employment of the pedal assembly activates the hub motor and each hub motor comprises a temperature sensor for measuring the operating temperature of the hub motors and each hub motor has the capability to generate an output current and further, each hub motor is mechanically associated with a wheel assembly;
a power supply; and
at least one motor controller in electrical communication with each hub motor and the power supply, wherein the motor controller continuously monitors the operating temperature of each hub motor.

24. The vehicle of claim 23, wherein the motor controller monitors the rpm, input current to the hub motors and generated output current of each hub motor.

25. The vehicle of claim 24, wherein if the motor controller determines that a hub motor's temperature is within a predetermined temperature range then the motor controller will decrease the current to the hub motor.

26. The vehicle of claim 25, wherein the motor controller determines the amount of current required by each hub motor based upon input from a vehicle user interface.

27. The vehicle of claim 26, wherein the power supply comprises recharging circuitry.

28. The vehicle of claim 27, wherein a wheel assembly braking function initiates the motor hub generator mode.

29. The vehicle of claim 28, wherein the vehicle human interface comprises a throttle.
